(19) United States
(12) Patent Application Publication
(10) Pub. No.: US 2005/0037769 A1
(43) Pub. Date: Feb. 17, 2005

(54) Alleviating an overload condition of a base station for mobile telecommunications

(76) Inventors: Iqbal Jami, Swindon (GB); Mazlyn Mona Mustapha, Swindon (GB); Prashant K. Padhy, Aurora, IL (US)

Correspondence Address: Lucent Technologies Inc., Docket Administrator (Room 3J-219), 101 Crawfords Corner Road, Holmdel, NJ, 07733-3030, US

(21) Appl. No.: 10/639,234

(22) Filed: Aug. 12, 2003

(51) Int. Cl. H04Q 7/20

(52) U.S. Cl. 455/453; 455/458; 455/436

(57) ABSTRACT

A method is provided of alleviating an overload condition of a base station of a code division multiple access (CDMA) network for mobile telecommunications. The base station has a plurality of mobile user terminals in its radio coverage area. At least some of the mobile user terminals are in a first mode in which a request for non-emergency call connection can be made. The method involves detecting an overload condition of the base station and in response transferring a mobile user terminal from said first mode to a second mode in which the mobile user terminal can no longer make a request for non-emergency call connection.

### FIELD OF THE INVENTION

The present invention relates to a method of alleviating an overload condition of a base station of a code division multiple access (CDMA) network for mobile telecommunications. The present invention also relates to a CDMA network, to a base station, and to a base station controller.

### DESCRIPTION OF THE RELATED ART

When a base station controller is in an overloaded state such that it can handle no more calls with acceptable quality of service, the usual strategy to recover from overload is to prevent new calls from being set up, be they mobile-originated or mobile-terminated. Using this strategy, the number of calls being handled by the base station controller is reduced over time as the calls and the mobile user terminals move out of the overloaded system. This gradually reduces the load on the base station controller until the base station controller is no longer in an overloaded condition.

However, this strategy is of little use if the mobile user terminals remain call connected and do not move sufficiently to become connected to another base station controller. Furthermore, if calls are still being set up at the base station controller for whatever reason, for example calls being handed over from another base station controller, the overload condition will worsen.

In a UMTS network, packet-switched users can remain connected to the core network without any call connections to the base station controller which in a UMTS network is a radio network controller (RNC). In this state, the mobile user terminal periodically updates the base station controller as to its UTRAN Registration Area. This ‘pseudo-idle’ state is called UTRAN Registration Area Paging Channel state (usually abbreviated to URA_PCH state). If a mobile user terminal in URA_PCH state wishes to send or receive packet data, the mobile user terminal is moved into either Cell_DCH state or Cell_FACH state, in which dedicated or shared resources for call connection are granted by the base station controller. Mobile user terminals in URA_PCH state do not require much of the base station controller's radio resources.

### SUMMARY OF THE INVENTION

A method of alleviating an overload condition of a base station, a code division multiple access (CDMA) network, a base station, and a base station controller, according to the present invention are defined in the independent claims to which the reader should now refer. Preferred features are laid out in the dependent claims.

An example of the present invention is a method of alleviating an overload condition of a base station of a code division multiple access (CDMA) network for mobile telecommunications. The base station has a plurality of mobile user terminals in its radio coverage area. At least some of the mobile user terminals are in a first mode in which a request for non-emergency call connection can be made. The method involves detecting an overload condition of the base station and in response transferring a mobile user terminal from said first mode to a second mode in which the mobile user terminal can no longer make a request for non-emergency call connection.

When considering in particular a known UMTS network, the inventors realised that there was a problem that arises when the base station controller is in an overloaded condition and mobile user terminals in URA_PCH state seek to move to an active call connected state (Cell_DCH state or Cell_FACH state) by requesting appropriate radio resources. Whenever a mobile user terminal needs to make an emergency call (e.g. 911) when in URA_PCH state, it requests the radio resources from the base station controller, and because the base station controller cannot distinguish whether a mobile user terminal requests the resources because of a desire to send packet data or a need to make an emergency call, the base station controller cannot reject this request. Rejecting a call setup request which might be for an emergency call is not only dangerous but also violates telecommunications regulations in some countries. However, by having to accept all mobile user terminal requests for resources, the base station controller worsens the overload condition that it is experiencing, especially if the number of mobile user terminals making such requests is large. This increases the risk of poor functioning of the base station controller to the extent that the base station controller might even crash causing all calls to be lost. A preferred embodiment of the present invention advantageously addresses this problem by transferring mobile user terminal(s) to a mode in which a terminal can no longer make a request for non-emergency call connection.

### BRIEF DESCRIPTION OF THE DRAWINGS

A preferred embodiment of the present invention will now be described by way of example and with reference to the drawings, in which:

FIG. 1 is a diagram illustrating a preferred network, which is a UMTS network,

FIG. 2 is a diagram of the radio network controller (RNC) and one of the transmitter-receiver stations shown in FIG. 1,

FIG. 3 is a diagram illustrating grouping of mobile user terminals by an RNC dependent on time already spent in URA_PCH state,

FIG. 4 is a diagram illustrating transfer of mobile user terminals to idle state when the RNC is overloaded, and

FIG. 5 is a message sequence diagram showing messaging between a radio network controller (RNC) and a mobile user terminal (UE) in a preferred UMTS network.

### DETAILED DESCRIPTION

The preferred network is a Universal Mobile Telecommunications System (UMTS) terrestrial access network (UTRAN), which is a type of wideband code division multiple access (CDMA) network for mobile telecommunications. The network includes a radio network controller (RNC) which controls at least one transmitter-receiver station. Basically, it is proposed that when the RNC is in an overloaded condition, mobile user terminals in a connected mode (URA_PCH state) are moved to idle state where all connections between the mobile user terminal and the network are severed. By moving user terminals that are in URA_PCH state to idle state, a UTRAN network that is in an overloaded condition is protected from going further into overload. This is because connection requests from some mobile user terminals in URA_PCH state wanting to move to another more active state (namely Cell_DCH state) are avoided by moving those mobile user terminals to idle state. Mobile user terminals in URA_PCH state are moved to idle state by releasing the radio resources allocated thereto by the RNC. The mobile user terminal can then either reconnect to a different RNC, if there is one, or stay in idle state. Additionally, if the mobile user terminal does need to initiate emergency calls, it will be processed by the RNC via a request for resources for emergency calls from the idle state. In URA_PCH state, the mobile user terminal listens periodically to a paging channel. In idle state, the mobile user terminal listens somewhat less frequently to the paging channel.

The UTRAN network is basically as shown in FIG. 1. A base station made up of only one radio network controller and two transmitter-receiver stations of the UTRAN network 2 is shown for simplicity. As shown in this Figure, the UTRAN network 2 includes transmitter-receiver stations 4. Each transmitter-receiver station (Node B in UMTS terminology) 4 typically has three cells 6 (i.e. radio coverage areas, also known as sectors) as the transmitter-receiver station 4 typically has three directional antennas (not shown) angled at 120 degrees to each other in azimuth. Radio network controllers (RNC) 8 which are themselves connected to the rest of the telecommunications “world” (not shown) each control several transmitter-receiver stations 4 and hence a number of cells 6. A transmitter-receiver station 4 is connected to its controlling radio network controller (RNC) 8 via a respective interface 10 known as an IuB interface. In use, a mobile user terminal 12 (often referred to as User Equipment (UE) in UMTS terminology) communicates with a serving radio network controller (RNC) 8 via at least one cell 6 of at least one transmitter-receiver station 4 (i.e. communicates with the UTRAN network 2).

URA_PCH State

When in the UMTS network, a mobile user terminal using packet-switched services can be connected without a call connection to the base station controller. In this state, the mobile user terminal periodically updates the base station controller as to its UTRAN Registration Area. This ‘pseudo-idle’ state is called UTRAN Registration Area Paging Channel state (usually abbreviated to URA_PCH state).

If a mobile user terminal in URA_PCH state wishes to send or receive packet data, the mobile user terminal is moved into either Cell_DCH state or Cell_FACH state, in which dedicated resources are granted by the base station controller. Similarly if a mobile user terminal needs to make an emergency call (e.g. 911) when in URA_PCH state, it requests resources from the base station controller.

The base station controller cannot distinguish whether a mobile user terminal requests the resources in order to either send/receive packet data or to make an emergency call. Accordingly, the base station controller must grant the request.

Dealing with an Overload Condition at a Radio Network Controller (RNC)

When the radio network controller (RNC) is in overload, some of mobile user terminals in URA_PCH state are moved to idle state. In idle state, the mobile user terminal and RNC no longer communicate. In this case, if the mobile user terminal that has been moved to idle state wishes to initiate an emergency call, it can do so by requesting a connection for an emergency call, thus notifying the RNC of its intentions, and this request should not be rejected by the RNC.

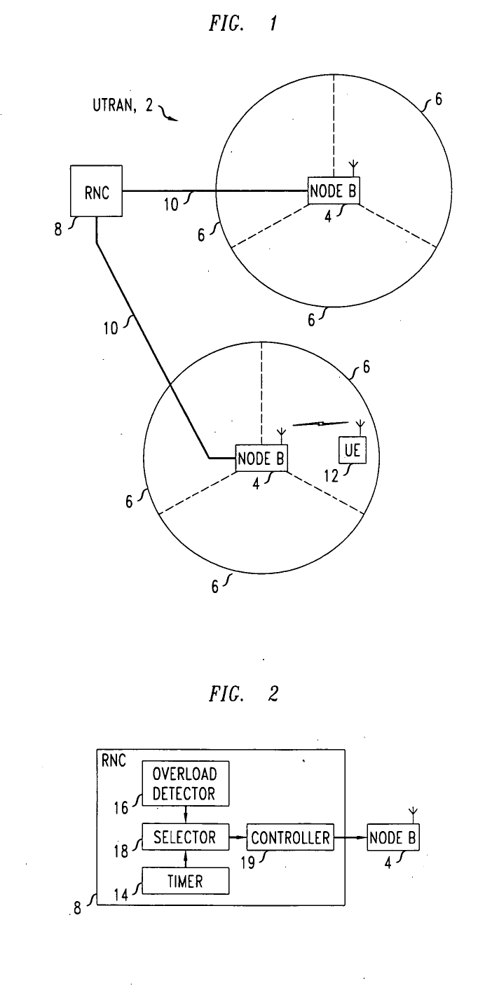

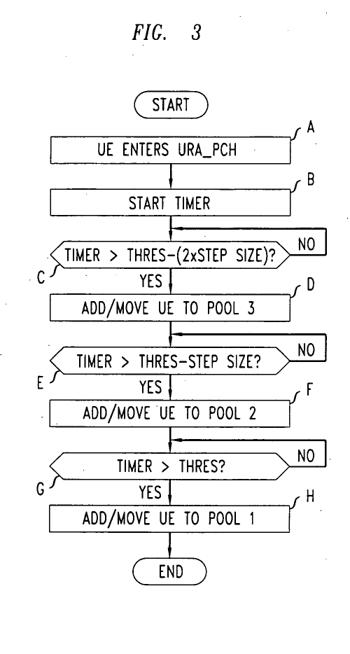

As shown in FIG. 3, and with reference to FIG. 2, when a mobile user terminal enters (step a) URA_PCH state, a timer 14 is started (b) at the RNC. Accordingly the RNC knows for how long the mobile user terminal has been in URA_PCH state. This timer 14 is stopped only when the RNC receives a response from the mobile user terminal to a paging message or when the mobile user terminal attempts to move to Cell_DCH state. The RNC also stores a time threshold value (“thres”) and a time increment value (“step size”). The RNC includes a processor (part of selector stage 18 explained further below) which compares the time period measured by the timer to a series of thresholds dependent on the “thres” value. Specifically, mobile user terminals determined (step c) as being in URA_PCH state for a period t where t>(thres−2*step size) are added (step d) to a pool (Pool 3). User terminals determined (step e) as being in URA_PCH state for a period t, where t>(thres−step size), are shifted (step f) to a second pool (Pool 2). User terminals determined (step g) as being in URA_PCH state for a period t, where t>thres are shifted on (step h) to a further pool (Pool 1).

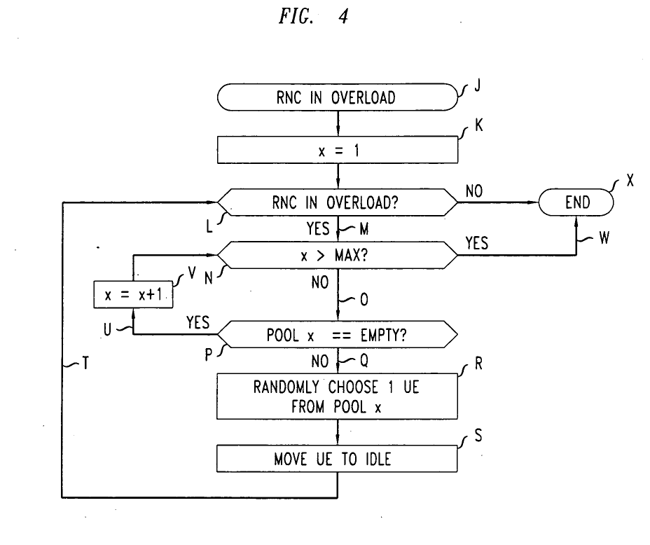

The radio network controller (RNC) includes an overload detector as shown in FIG. 2. As shown in FIG. 4 and with reference to FIG. 2, when the RNC is detected as in an overloaded condition, the RNC includes a selector stage 18 which randomly selects a mobile user terminal from Pool 1 and a controller 19 which shifts this mobile user terminal to idle state by instructing appropriate control signalling between the relevant base station (NodeB) and the mobile user terminal . The RNC needs to shift the mobile user terminals to idle state one by one so as not to exacerbate the overload condition. The RNC continues to move mobile user terminals in Pool 1 to idle state until either the RNC has recovered from overload, or there are no more mobile user terminals in Pool 1.

Whilst the overload condition continues, if there are no mobile user terminals in Pool 1, the RNC proceeds to move mobile user terminals from Pool 2 to idle state instead. Similarly, if there are no mobile user terminals in Pool 1, the RNC proceeds to move mobile user terminals from Pool 3 to idle state instead. If there are no mobile user terminals left in any of the Pools, the RNC necessarily stops moving mobile user terminals to idle state even though the overload condition continues.

To explain this approach further, as shown in FIG. 4,

(j) the RNC is first determined as being in an overload condition,

(k) pool 1 is selected (by having pool designator=1),

(l) a determination is made whether the RNC is still in the overload condition,

(m) if yes, (n) a determination is made as to whether the pool designator x has a value higher than that designating the highest pool available (in this example, which has three pools, pool 3 is considered higher than pool 2 which is higher than pool 1),

(o) if the pool designator x (i.e. selected pool) is not higher than the highest available, (p) a determination is made as to whether the currently selected pool is empty of mobile user terminal candidates for being put into idle mode,

(q) if the currently selected pool is not empty, (r) one of the mobile user terminal candidates is selected at random, and (s) is put into idle mode, and (t) a return is made to step (l).

(u) If the currently selected pool is empty, (v) the next highest pool is selected (by incrementing pool designator x by 1), and a return is made to step (n). Once (w) all available pools have been considered, the process ends (x).

Mechanism for Transferring a Selected Mobile User Terminal to Idle Mode

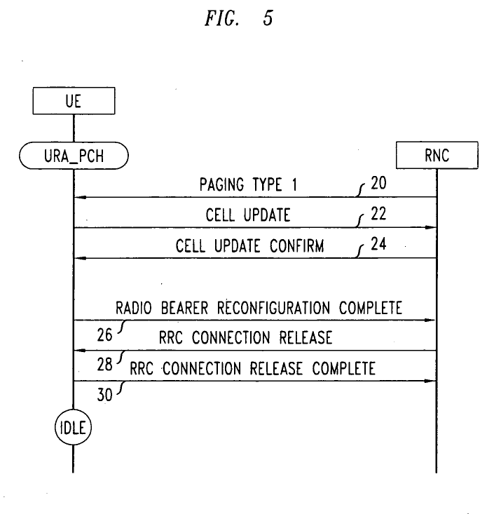

The messaging involved in getting a selected mobile user terminal to transfer to idle mode will now be explained with reference to FIG. 5. As shown in FIG. 5, once the radio network controller (RNC) has selected a mobile user terminal (UE) to be moved from URA_PCH to idle mode, the RNC first sends a Paging Type 1 message (reference numeral 20 as shown in the FIG. 5) to initiate contact with the selected mobile user terminal, as the mobile user terminal does not have a dedicated signalling connection with the RNC. The mobile user terminal responds with a Cell Update message 22 including a request for a dedicated signalling channel. This request is granted by the RNC replying with a Cell Update Confirm message 24.

The mobile user terminal uses the signalling channel setting in the received Cell Update Confirm message and responds to the RNC with a Radio Bearer Reconfiguration message 26 when it has completed configuring its signalling channel. The RNC then instructs the mobile user terminal to move to idle mode by sending a radio resource control (RRC) Connection Release message 28. The mobile user terminal then confirms that it is going into idle mode by sending a RRC Connection Release Confirm message 30, and then enters idle mode.

The Messages Between the RNC and Mobile User Terminal are, of Course, Via the Transmitter-Receiver Station (Node B) in the Radio Coverage Area (Cell) in which the Mobile User Terminal Currently Resides.

1. A method of alleviating an overload condition of a base station of a code division multiple access (CDMA) network for mobile telecommunications, the base station having a plurality of mobile user terminals in its radio coverage area, at least some of the mobile user terminals being in a first mode in which a request for non-emergency call connection can be made, the method comprising detecting an overload condition of the base station and in response transferring a mobile user terminal from said first mode to a second mode in which the mobile user terminal can no longer make a request for non-emergency call connection.

2. A method according to claim 1, in which said first mode is UTRAN Registration Area Paging Channel (URA_PCH) mode, said second mode is idle mode, and the network is a Universal Mobile Telecommunications System (UTMTS) network.

3. A method according to claim 1, in which the mobile user terminal is selected dependent upon the time elapsed since entering said first mode.

4. A method according to claim 3, in which the mobile user terminals currently in the first mode are grouped dependent on in which of a series of time bands their time elapsed since entering said first mode fall, the mobile for transfer being selected from the group of mobile user terminals with the currently longest time band.

5. A method according to claim 4, in which the mobile for transfer is selected randomly from the group of mobile user terminals with the currently longest time band.

6. A method according to claim 4, in which further mobile user terminals in the first mode are selected over time for transfer to the second mode, each further mobile user terminal being selected from the group at the time of selection with longest time band.

7. A method according to claim 1, in which the mobile user terminal in the second mode handovers to another base station.

8. A method according to claim 1, in which a mobile user terminal in the second mode can make a request for emergency call connection.

9. A method according to claim 1, in which said first mode involves the mobile user terminal periodically listening to a paging channel from the base station, and in which in said second mode the mobile user terminal listens less frequently to the paging channel.

10. A code division multiple access (CDMA) network for mobile telecommunications comprising a base station, the base station in use having a plurality of mobile user terminals in its radio coverage area, at least some of the mobile user terminals being in a first mode in which a request for non-emergency call connection can be made, the base station comprising a detector to detect an overload condition, a selector to select a mobile user terminal noted by the base station as being in the first mode, and a transmitter operative to send an instruction, in response to the detection of the overload condition, that the selected mobile user terminal move to a second mode in which the mobile user terminal can no longer make a request for non-emergency call connection.

11. A network according to claim 10, in which the network is a Universal Mobile Telecommunications System (UMTS) network, said first mode is UTRAN Registration Area Paging Channel (URA_PCH) mode, and said second mode is idle mode.

12. A network according to claim 10, in which the selector is operative to select the mobile user terminal dependent upon the time elapsed since entering said first mode.

13. A network according to claim 12, in which the selector is operative to group the mobile user terminals currently in the first mode dependent on in which of a series of time bands their time elapsed since entering said first mode fall, the mobile for transfer being selected from the group of mobile user terminals with the currently longest time band.

14. A network according to claim 13, in which the selector is operative to select the mobile user terminal for transfer randomly from the group of mobile user terminals with the currently longest time band.

15. A network according to claim 13, in which the selector is operative to select further mobile user terminals in the first mode over time for transfer to the second mode, each further mobile user terminal being selected from the group at the time of selection with longest time band.

16. A network according to claim 10, in which a mobile user terminal in the second mode can make a request for emergency call connection.

17. A network according to claim 10, in which said first mode involves the mobile user terminal periodically listening to a paging channel from the base station, and in which in said second mode the mobile user terminal listens less frequently to the paging channel.

18. A code division multiple access (CDMA) base station having a radio coverage area for communication with mobile user terminals, the base station comprising a detector to detect an overload condition, a selector to select a mobile user terminal noted by the base station as being in a mode in which a request for non-emergency call connection can be made, and a transmitter operative to send an instruction, in response to the detection of the overload condition, that the selected mobile user terminal move to a mode in which a request for non-emergency call connection can no longer be made.

19. A code division multiple access (CDMA) base station according to claim 17 comprising a base station controller and at least one transmitter-receiver station.

20. A code division multiple access (CDMA) base station controller, operative to control at least one base transmitter-receiver station, the base station controller comprising a detector to detect an overload condition of the base station controller, a selector to select a mobile user terminal noted by the base station controller as being in a mode in which a request for non-emergency call connection can be made, and a controller stage operative to instruct a base transmitter-receiver station to transmit an instruction, in response to the detection of the overload condition, the instruction being that the selected mobile user terminal move to a mode in which a request for non-emergency call connection can no longer be made.
